(19) United States
(12) Patent Application Publication
(10) Pub. No.: US 2023/0058387 A1
(43) Pub. Date: Feb. 23, 2023

(54) PARTITIONING OF OBJECTS FOR ADDITIVE MANUFACTURE

(71) Applicant: Baker Hughes Oilfield Operations LLC, Houston, TX (US)

(72) Inventors: Navin Sakthivel, Spring, TX (US); Anjani Achanta, Spring, TX (US)

(21) Appl. No.: 17/406,435

(22) Filed: Aug. 19, 2021

(51) Int. Cl. G05B 19/4099

(52) U.S. Cl. CPC G05B 19/4099; G05B 2219/49023

(57) ABSTRACT

One or more embodiments of the present disclosure relate to partitioning of objects for additive manufacture. A method may include defining one or more partition lines in an object of a build file. The build file may comprise instructions for additively manufacturing the object. The method may also include generating part build files based on the build file and the one or more partition lines. The part build files may comprise instructions for additively manufacturing parts of the object. The method may also include generating a physical instance of each part of the object according to the part build files. The method may also include assembling the physical instances of the parts into a physical instance of the object. The method may also include applying heat to the physical instance of the object. Related devices, systems and methods are also disclosed.

### TECHNICAL FIELD

This description relates, generally, to additive manufacturing. More specifically, some embodiments relate to partitioning of objects for additive manufacture, without limitation. Related methods, systems, and apparatus are disclosed.

### BACKGROUND

Additive manufacture includes the generation of a three-dimensional object by successive addition of small portions of a material (e.g., in layers). Additive manufacture is typically a computer-controlled process in which a computer controls one or more machines to generate the object according to a build file. Additive manufacture can include a variety of processes in which the material is successively deposited, joined, and/or solidified.

One example of additive manufacture is binder jetting. In binder jetting, a layer of powdered material is deposited on a build bed. A liquid binding agent is then applied to the powered material in a specific pattern (i.e., corresponding to a layer of the object to be generated). The binding agent can be applied by one or more dispensers that are moved laterally above the build bed in a build chamber. The binding agent is allowed to dry, or is dried (e.g., by application of heat). The dried binding agent, where applied, binds powdered material together. A subsequent layer of powdered material is deposited on the build bed over the prior layer including (including the portion bound by the binding agent). The liquid binding agent is applied to the subsequent layer in a subsequent specific pattern (i.e., corresponding to a subsequent layer of the object). This process is repeated to generate successive layers of the object. Following generation of the object (i.e., after the last layer is bound and dried), excess powdered material is removed from the object. In some cases, binding jetting includes further drying the object after the last layer of the object is added. In some cases, the object can then be finished, e.g., by application of heat e.g., in a process such as sintering. The application of heat can bond the powdered particles together.

### BRIEF DESCRIPTION THE DRAWINGS

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 is a functional block diagram illustrating an example workflow according to one or more embodiments.

FIG. 2 illustrates an example object according to one or more embodiments.

FIG. 3 is a flowchart of an example method, in accordance with one or more embodiments.

FIG. 4 is a flowchart of another example method, in accordance with one or more embodiments.

FIG. 5 is a block diagram of an example device that, in various embodiments, may be used to implement various functions, operations, acts, processes, and/or methods disclosed herein.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, acts, features, functions, or the like.

It will be readily understood that the components of the embodiments as generally described herein and illustrated in the drawing could be arranged and designed in a wide variety of different configurations. Thus, the following description of various embodiments is not intended to limit the scope of the present disclosure, but is merely representative of various embodiments. While the various aspects of the embodiments may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be depicted by block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. For example, data, instructions, commands, information, signals, bits, and symbols that may be referenced throughout this description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal. A person having ordinary skill in the art would appreciate that this disclosure encompasses communication of quantum information and qubits used to represent quantum information.

The various illustrative logical blocks, modules, and circuits described in connection with the embodiments disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure.

Some embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, or a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Various additive manufacturing processes involve generating an object by successively adding portions (e.g., layers) of material to the object upon a build bed within a build chamber. The build chamber may have dimensions in which objects can be generated. For example, a binder-jetting build chamber may include lateral dimensions within which one or more jets can be mechanically positioned above the build bed. Further, the binding-jetting build chamber may include a depth dimension to which the build bed can be lowered below the jets (and/or the powdered material depositor). Thus, the binder-jetting build chamber lacks a capability to generate objects that exceed the lateral or depth dimension of the binder-jetting build chamber.

Some embodiments may enable additive manufacture of objects that exceed dimensions of a build chamber in which the objects are generated. For example, some embodiments may include defining one or more partitioning lines that partition an object into two or more parts. The partition lines may be defined such that the parts defined by the partition lines do not exceed a size threshold (e.g., dimensions achievable by a build chamber) even if the object as a whole exceeds one of more of the size thresholds.

The two or more parts may be generated separately (e.g., successively in a build chamber or in separate build chambers). The generated parts may then be assembled. In some embodiments, after the parts are assembled, the assembled parts may be finished, e.g., by application of heat e.g., in a process such as sintering. Finishing the assembled parts may cause the parts to be joined together. Some embodiments may include generating the two or more parts through binder jetting, assembling the two or more parts, and then sintering the two or more parts together.

In some embodiments, the partition lines may be defined based at least in part on a mechanical model of the object. For example, the object may be simulated and stresses on the object may be analyzed (e.g., using a finite-element analysis, numerical methods, finite volume method, empirical calculations, and/or real-time diffraction measurement techniques). Low-stress locations of the object may be identified and the partition lines may be defined to be located proximate to the low-stress locations.

Additionally or alternatively, the partition lines may be defined based at least in part on a thermal model of the object. For example, the object may be simulated and thermal gradients of the object may be analyzed (e.g., using a finite element analysis, thermal imaging (e.g., during actual generation of an object), and/or numerical methods for simulation before generation of the object). Low-temperature-gradient locations of the object may be identified and the partition lines may be defined to be located proximate to the low-temperature-gradient locations.

Additionally or alternatively, complementary features may be added to complementary edges of parts defined by partition lines. For example, at a boundary between two parts, defined by a partition line, complementary features may be added to both parts. The complementary features may interlock to increase surface area of the two parts that will touch and be bound during sintering. Further the addition of complementary features may increase tension forces between parts when they are assembled prior to sintering.

Further, in some embodiments, finishing material may be applied to edges between parts. The finishing material may include binding material and/or matrix material (i.e., the material of which the object is generated).

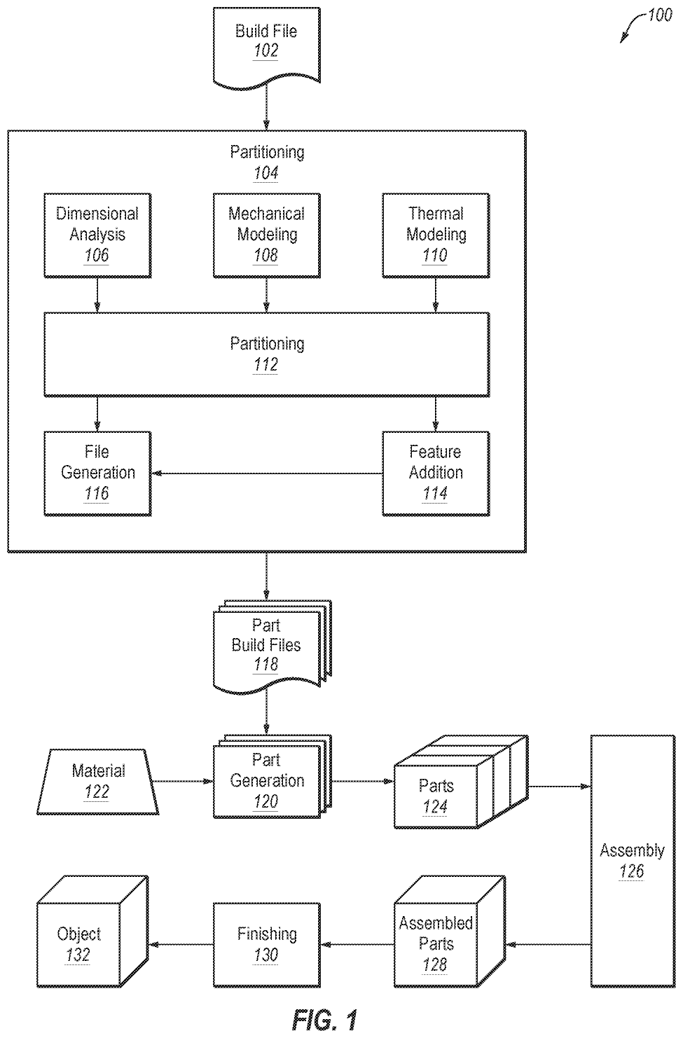

FIG. 1 is a functional block diagram illustrating an example workflow 100 according to one or more embodiments. Workflow 100 may include one or more embodiments, e.g., methods. Additionally or alternatively, workflow 100 may include one or more devices and/or systems configured to implement one or more embodiments. For example, workflow 100 may be performed at one or more computing systems, one or more additive-manufacturing systems, one or more part assembly systems, and one or more finishing systems. In general, workflow 100 may include partitioning a build file 102 into part build files 118, generating parts 124, assembling parts 124 into assembled parts 128, and finishing assembled parts 128 to complete object 132.

Build file 102 may be or may include instructions for generating object 132 through additive manufacture. Build file 102 may include patterns for multiple layers of object 132.

Workflow 100 may include partitioning 104, at which build file 102 may be partitioned into part build files 118. As an example, one or more dimensions of build file 102 may exceed a size threshold. For example, one or more dimensions of build file 102 may exceed a dimension of a build chamber or a capability of an additive manufacturing device. At partitioning 104, build file 102 may be partitioned into part build files 118 which may not exceed the size threshold. As another example, it may be faster or more cost-effective to generate an object in component parts rather than all at once. Accordingly, there may be size thresholds, for example requirements to maintain dimensional tolerances, indicating a preference for smaller parts rather than larger objects. At partitioning 104, build file 102 may be partitioned into part build files 118 that may allow generation of the object in parts rather than all at once. Partitioning 104 may be performed at one or more computing systems.

Partitioning 104 may include dimensional analysis 106 at which build file 102 may be analyzed to determine whether any dimension of build file 102 exceeds a size threshold. Dimensional analysis 106 may be configured to provide dimension recommendations indicative of part sizes that do not exceed the size threshold. For example, if build file 102 includes a length that is twice as long as than a size threshold, dimensional analysis 106 may recommend partitioning build file 102 along the length dimension into three part build files 118.

Partitioning 104 may include mechanical modeling 108 at which a mechanical analysis of build file 102 or of a simulated object (i.e., an object simulated according to build file 102) may be performed. Mechanical modeling 108 may include performing a stress analysis of build file 102 (or of the simulated object) to determine stresses at one or more locations of the simulated object. Mechanical modeling 108 may include a finite-element analysis of the simulated object. Mechanical modeling 108 may be configured to identify low-stress locations of the build file 102 or of the simulated object. Mechanical modeling 108 may be configured (i.e., programmed) to provide indications of the low-stress locations e.g., as recommendations for suitable locations for partition lines.

Partitioning 104 may include thermal modeling 110 at which a thermal analysis of build file 102 or of a simulated object (i.e., an object simulated according to build file 102) may be performed. Thermal modeling 110 may include performing a thermal analysis of build file 102 (or of the simulated object) to determine a thermal gradient at one or more locations of the simulated object. Thermal modeling 110 may include a finite-element analysis of the simulated object. Thermal modeling 110 may be configured (i.e., programmed) to identify low-temperature-gradient locations of the build file 102 or of the simulated object. Thermal modeling 110 may be configured to provide indications of the low-temperature-gradient locations e.g., as recommendations for suitable locations for partition lines.

Partitioning 104 may include partitioning 112 at which partition lines may be identified to partition build file 102 into part build files 118. The partition lines may be defined based at least in part on one or more of dimensional recommendations, low-stress locations, and/or low-temperature-gradient locations. For example, partitioning 112 may be configured to select optimized low-stress locations and/or low-temperature-gradient locations that partition build file 102 into part build files 118 that satisfy the size thresholds.

Partitioning 104 may include feature addition 114 at which complementary features may be added along complementary sides of at least one partition line between two parts. For example, after the definition of partition lines between parts, complementary features (e.g., interlocking protrusions and recesses, including e.g., three-dimensional protrusions and recesses) may be added to complementary sides of the partition lines between the parts. Examples of the complementary features may include a pin and a socket, a split pin and a socket, a hollow cylinder and a shaft/piston.

Partitioning 104 may include file generation 116 at which part build files 118 may be generated according to build file 102 and the partition lines. Part build files 118 may be instructions for generating parts 124 through additive manufacture.

Workflow 100 may include part generation 120 at which parts 124 may be generated from material 122 according to part build files 118. Part generation 120 may include any suitable additive manufacture process, e.g., binder jetting. Implementation of embodiments of the disclosure is not limited to specific additive manufacturing processes, the selection of which for manufacturing of a given object may be based on material or materials of the object as well as the intended environment (e.g., temperature, stresses, chemical environment, etc.) in which the object is to be deployed. Part generations 120 may be performed sequentially by a single piece of additive-manufacturing equipment or by multiple pieces of additive-manufacturing equipment (e.g., simultaneously).

Workflow 100 may include assembly 126 at which parts 124 may be assembled to form assembled parts 128. Assembly 126 may include interlocking complementary features of parts 124. The complementary features may provide increased surface area between assembled parts 128. Further the complementary features may increase tension forces between assembled parts 128. In some embodiments, assembly 126 may include inserting pins e.g., cotter pins, into complementary features (e.g., protrusions and recesses). The cotter pins may be of material 122 (i.e., the material of which parts 124 are generated). In some embodiments, assembly 126 may include adding finishing material to edges between parts (e.g., edges corresponding to partition lines). The finishing material may include binding material (e.g., binder used in part generation 120) and/or matrix material (i.e., the material 122 of which the object is generated). Assembly 126 may be performed by one or more assembly systems or by one or more assemblers. An assembly system may include machinery configured to assemble parts 124 into assembled parts 128.

Workflow 100 may include finishing 130 which may include application of heat to assembled parts 128. Finishing 130 may include heating assembled parts 128 to a point near the melting point of material 122 such that assembled parts 128 bond together. Finishing 130 may include sintering in the case of binder jetting. Of course other additive manufacturing techniques such as those noted above may employ different or additional finishing techniques. Examples of finishing may include hot-isostatic pressing, vacuum infiltration, laser cladding, and heat treatment. Finishing 130 may be performed by one or more finishing systems, e.g., a sintering oven.

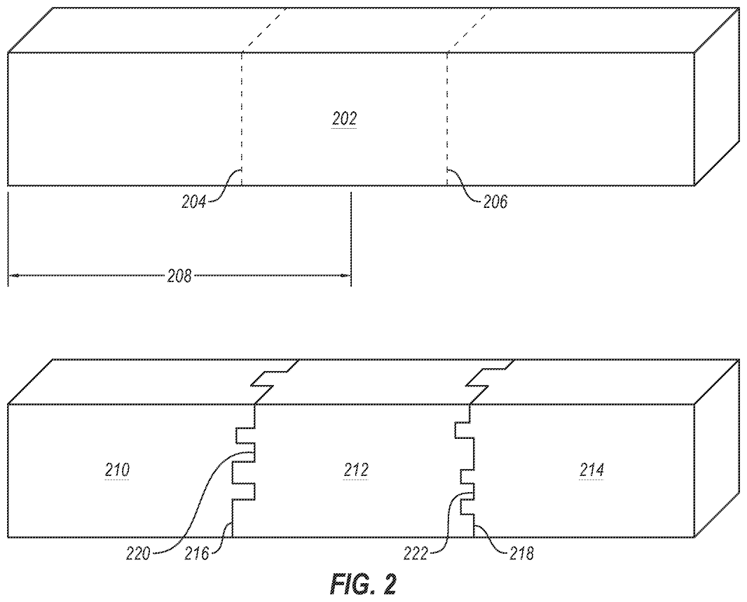

FIG. 2 illustrates an example object 202 according to one or more embodiments. For example, object 202 exceeds size threshold 208 in dimension. According to one or more embodiments, object 202 may be partitioned by partition line 204 and partition line 206 into parts (e.g., part 210, part 212, and part 214). Further, partition line 216 and partition line 218 (partitioning object 202 into part 210, part 212, and part 214) may include complementary features 220 and complementary features 222 respectively.

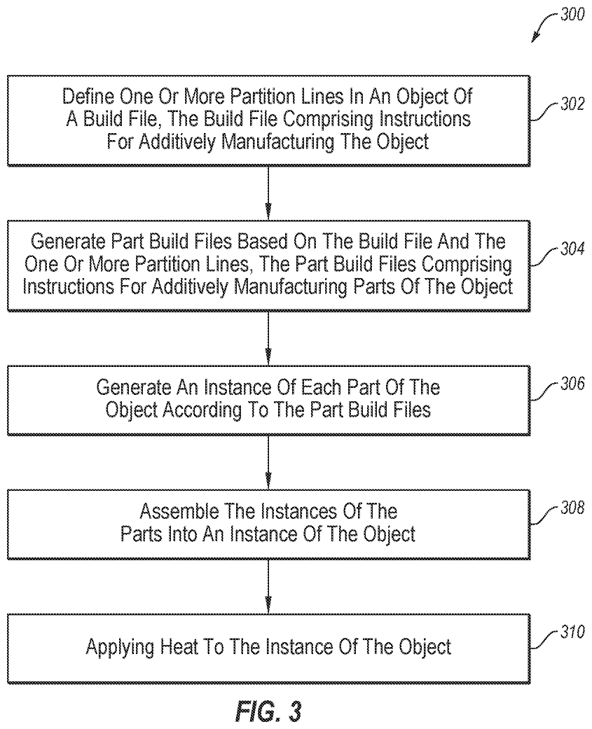

FIG. 3 is a flowchart of an example method 300, in accordance with one or more embodiments. At least a portion of method 300 may be performed, in some embodiments, by a device or system, e.g., according to workflow 100 of FIG. 1. Although illustrated as discrete blocks, various blocks may be divided into additional blocks, combined into fewer blocks, or eliminated, depending on the desired implementation.

At block 302, one or more partition lines in an object of a build file may be defined. The build file may be or may include instructions for additively manufacturing the object. Some of the operations described with relation to partitioning 104 (e.g., operations related to dimensional analysis 106, mechanical modeling 108, thermal modeling 110, partitioning 112, and/or feature addition 114) of FIG. 1 may be an example of the definition of partition lines of block 302.

Block 302 may include defining the partition lines based at least in part on a mechanical and/or thermal model of the object. For example, block 302 may include defining the partition lines based at least in part on low-stress locations and/or low-temperature-gradient locations identified in the object through analysis of the mechanical and/or thermal model of the object. Additionally or alternatively, block 302 may include defining the partition lines such that dimensions of each of the parts defined by the partition lines do not exceed a predetermined size threshold.

At block 304, part build files may be generated based on the build file and the one or more partition lines. The part build files may be or may include instructions for additively manufacturing parts of the object. Operations describe with relation to file generation 116 of FIG. 1 may be an example of the generation of the part build files of block 304.

In some embodiments, block 304 may include adding complementary features along complementary sides of at least one partition line between two parts. In other embodiments, the complementary features may be included as part of the definition of the partition lines e.g., at block 302.

At block 306, a physical instance of each part of the object may be generated according to the part build files. Operations described with relation to part generation 120 of FIG. 1 may be an example of the generating physical instances of parts of block 306. Generating the parts through binder jetting may be an example of the generation of the parts of block 306. Block 306 may be performed sequentially by a single piece of additive-manufacturing equipment or by separate pieces of additive-manufacturing equipment (e.g., simultaneously).

At block 308, the physical instances of the parts may be assembled into a physical instance of the object. Operations described with relation to assembly 126 of FIG. 1 may be an example of the assembling of the physical instances of the parts of block 308. Block 308 may include adding finishing material to edges of the parts that correspond to partition lines before assembling the parts.

At block 310, heat may be applied to the physical instance of the object. Operations described with relation to finishing 130 of FIG. 1 may be an example of the application of heat to the physical instance of the object of block 310. Sintering may be an example of the application of heat to the physical instance of the object of block 310.

Modifications, additions, or omissions may be made to method 300 without departing from the scope of the present disclosure. For example, the operations of method 300 may be implemented in differing order. Furthermore, the outlined operations and actions are only provided as examples, and some of the operations and actions may be optional, combined into fewer operations and actions, or expanded into additional operations and actions without detracting from the essence of the disclosed example.

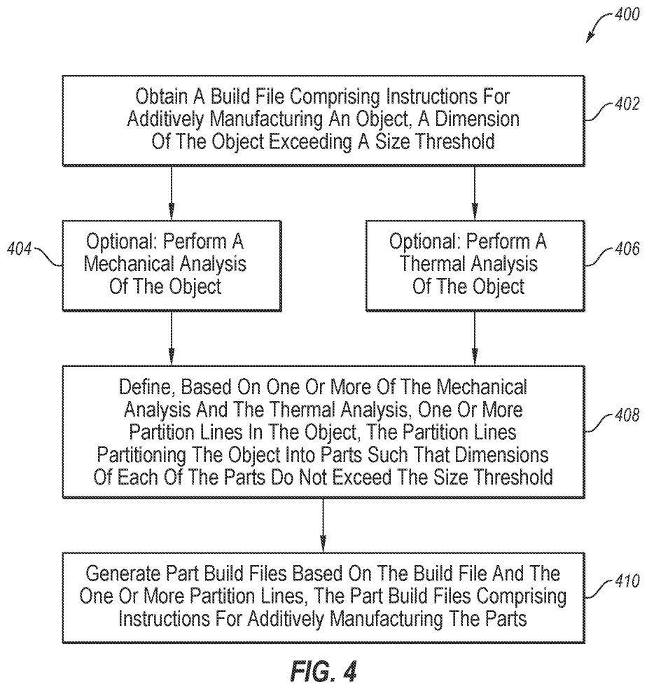

FIG. 4 is a flowchart of an example method 400, in accordance with one or more embodiments. At least a portion of method 400 may be performed, in some embodiments, by a device or system, e.g., according to workflow 100 of FIG. 1. Although illustrated as discrete blocks, various blocks may be divided into additional blocks, combined into fewer blocks, or eliminated, depending on the desired implementation.

At block 402, a build file comprising instructions for additively manufacturing an object may be obtained. A dimension of the object may exceed a predetermined size threshold. As an example, a dimension of the object may exceed a size buildable by a build chamber. As another example, a dimension of the object may be larger than is desirable to produce the object quickly and/or efficiently. For example, the object may be more quickly produced if produced in two or more separate build chambers in parts rather than in a single build chamber. Build file 102 of FIG. 1 may be an example of the build file obtained at block 402.

At block 404, an optional mechanical analysis of the object may be performed. The mechanical analysis may include identifying one or more low-stress locations in the object. Operations describe with relation to mechanical modeling 108 of FIG. 1 may be an example of the mechanical modeling of block 404.

At block 406, an optional thermal analysis of the object may be performed. The thermal analysis may include identifying one or more low-temperature-gradient locations in the object. Operations describe with relation to thermal modeling 110 of FIG. 1 may be an example of the thermal modeling of block 406.

At block 408, one or more partition lines may be defined in the object based at least in part on one or more of the mechanical analysis and the thermal analysis. The partition lines may partition the object into parts such that dimensions of each of the parts do not exceed the predetermined size threshold. The partition lines may be defined proximate the one or more low-stress locations and/or the one or more low-temperature-gradient locations. Operations describe with relation to partitioning 112 of FIG. 1 may be an example of the definition of partition lines of block 408.

At block 410, part build files may be generated based on the build file and the one or more partition lines. The part build files may be or may include instructions for additively manufacturing the parts. Operations describe with relation to file generation 116 of FIG. 1 may be an example of the generation of part build files of block 410.

In some embodiments, block 410 may include adding complementary features along complementary sides of at least one partition line between two parts. In other embodiments, the complementary features may be included as part of the definition of the partition lines e.g., at block 408.

Method 400 may include or may be followed by additional acts, including: generating a physical instance of each part of the object according to the part build files, assembling the physical instances of the parts into a physical instance of the object, and applying heat to the physical instance of the object.

Modifications, additions, or omissions may be made to method 400 without departing from the scope of the present disclosure. For example, the operations of method 400 may be implemented in differing order. Furthermore, the outlined operations and actions are only provided as examples, and some of the operations and actions may be optional, combined into fewer operations and actions, or expanded into additional operations and actions without detracting from the essence of the disclosed example.

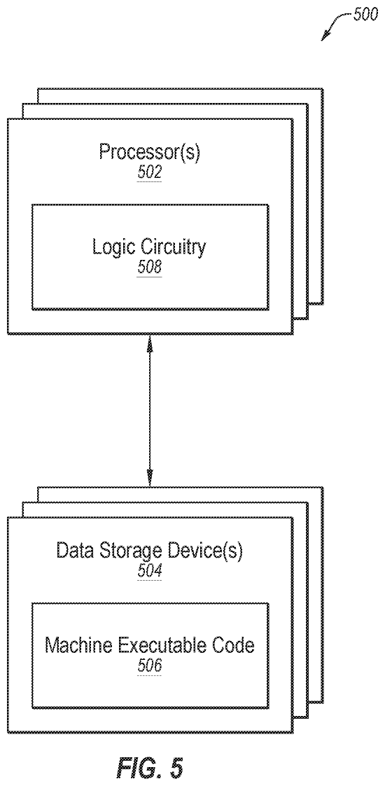

FIG. 5 is a block diagram of an example device 500 that, in various embodiments, may be used to implement various functions, operations, acts, processes, and/or methods disclosed herein. Device 500 includes one or more processors 502 (sometimes referred to herein as “processors 502”) operably coupled to one or more apparatuses such as data storage devices (sometimes referred to herein as “storage 504”), without limitation. Storage 504 includes machine executable code 506 stored thereon (e.g., stored on a computer-readable memory) and processors 502 include logic circuitry 508. Machine executable code 506 include information describing functional elements that may be implemented by (e.g., performed by) logic circuitry 508. Logic circuitry 508 is adapted to implement (e.g., perform) the functional elements described by machine executable code 506. Device 500, when executing the functional elements described by machine executable code 506, should be considered as special purpose hardware configured for carrying out the functional elements disclosed herein. In various embodiments, processors 502 may be configured to perform the functional elements described by machine executable code 506 sequentially, concurrently (e.g., on one or more different hardware platforms), or in one or more parallel process streams.

When implemented by logic circuitry 508 of processors 502, machine executable code 506 is configured to adapt processors 502 to perform operations of embodiments disclosed herein. For example, machine executable code 506 may be configured to adapt processors 502 to perform at least a portion or a totality of workflow 100 of FIG. 1, method 300 of FIG. 3, and/or method 400 of FIG. 4. As another example, machine executable code 506 may be configured to adapt processors 502 to perform at least a portion or a totality of the operations discussed for partitioning 104, including dimensional analysis 106, mechanical modeling 108, thermal modeling 110, partitioning 112, feature addition 114, and/or file generation 116. Further, machine executable code 506 may be configured to adapt processors 502 to perform at least a portion (e.g., controlling) of the operations discussed with regard to part generation 120, assembly 126, and/or finishing 130.

Processors 502 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer is configured to execute computing instructions (e.g., software code) related to embodiments of the present disclosure. It is noted that a general-purpose processor (may also be referred to herein as a host processor or simply a host) may be a microprocessor, but in the alternative, processors 502 may include any conventional processor, controller, microcontroller, or state machine. Processors 502 may also be implemented as a combination of computing devices, such as a combination of a DSP and a microprocessor, a plurality of microprocessors, one or more microprocessors in conjunction with a DSP core, or any other such configuration.

In some embodiments, storage 504 includes volatile data storage (e.g., random-access memory (RAM)), non-volatile data storage (e.g., Flash memory, a hard disc drive, a solid state drive, erasable programmable read-only memory (EPROM), without limitation). In some embodiments processors 502 and storage 504 may be implemented into a single device (e.g., a semiconductor device product, a system on chip (SOC), without limitation). In some embodiments processors 502 and storage 504 may be implemented into separate devices.

In some embodiments, machine executable code 506 may include computer-readable instructions (e.g., software code, firmware code). By way of non-limiting example, the computer-readable instructions may be stored by storage 504, accessed directly by processors 502, and executed by processors 502 using at least logic circuitry 508. Also by way of non-limiting example, the computer-readable instructions may be stored on storage 504, transmitted to a memory device (not shown) for execution, and executed by processors 502 using at least logic circuitry 508. Accordingly, in some embodiments logic circuitry 508 includes electrically configurable logic circuitry.

In some embodiments, machine executable code 506 may describe hardware (e.g., circuitry) to be implemented in logic circuitry 508 to perform the functional elements. This hardware may be described at any of a variety of levels of abstraction, from low-level transistor layouts to high-level description languages. At a high-level of abstraction, a hardware description language (HDL) such as an Institute of Electrical and Electronics Engineers (IEEE) Standard hardware description language (HDL) may be used, without limitation. By way of non-limiting examples, VERILOG™, SystemVerilog™ or very large scale integration (VLSI) hardware description language (VHDL™) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of logic circuitry 508 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some embodiments machine executable code 506 may include an HDL, an RTL, a GL description, a mask level description, other hardware description, or any combination thereof.

In some embodiments, where machine executable code 506 includes a hardware description (at any level of abstraction), a system (not shown, but including storage 504) may be configured to implement the hardware description described by machine executable code 506. By way of non-limiting example, processors 502 may include a programmable logic device (e.g., an FPGA or a PLC) and the logic circuitry 508 may be electrically controlled to implement circuitry corresponding to the hardware description into logic circuitry 508. Also by way of non-limiting example, logic circuitry 508 may include hard-wired logic manufactured by a manufacturing system (not shown, but including storage 504) according to the hardware description of machine executable code 506.

Regardless of whether machine executable code 506 includes computer-readable instructions or a hardware description, logic circuitry 508 is adapted to perform the functional elements described by machine executable code 506 when implementing the functional elements of machine executable code 506. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, without limitation) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different sub-combinations of some of the elements. For example, the phrase “A, B, C, D, or combinations thereof” may refer to any one of A, B, C, or D; the combination of each of A, B, C, and D; and any sub-combination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to some embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additional non-limiting some embodiments of the disclosure may include:

Embodiment 1: A method comprising: defining one or more partition lines in an object of a build file, the build file comprising instructions for additively manufacturing a physical implementation of the object of the build file; generating part build files based on the build file and the one or more partition lines, the part build files comprising instructions for additively manufacturing parts of the object; generating a physical instance of each part of the object according to the part build files; assembling the physical instances of the parts into a physical instance of the object; and applying heat to the physical instance of the object.

Embodiment 2: The method according to Embodiment 1, wherein defining the one or more partition lines further comprises defining the one or more partition lines based at least in part on a mechanical model of the object.

Embodiment 3: The method according to any of Embodiments 1 and 2, wherein defining the one or more partition lines further comprises identifying one or more low-stress locations in a mechanical model of the object and defining the one or more partition lines proximate the one or more low-stress locations.

Embodiment 4: The method according to any of Embodiments 1 through 3, wherein defining the one or more partition lines further comprises defining the one or more partition lines based at least in part on a thermal model of the object.

Embodiment 5: The method according to any of Embodiments 1 through 4, wherein defining the one or more partition lines further comprises identifying one or more low-temperature-gradient locations in a thermal model of the object and defining the one or more partition lines proximate the one or more low-temperature-gradient locations.

Embodiment 6: The method according to any of Embodiments 1 through 5, wherein defining the one or more partition lines in the object further comprises defining the partition lines such that dimensions of each of the parts do not exceed a predetermined size threshold.

Embodiment 7: The method according to any of Embodiments 1 through 6, wherein generating the part build files further comprises adding complementary features along complementary sides of at least one partition line between two parts.

Embodiment 8: The method according to any of Embodiments 1 through 7, wherein generating the parts further comprises generating the parts through binder jetting.

Embodiment 9: The method according to any of Embodiments 1 through 8, further comprising adding finishing material to edges of the parts corresponding to partition lines before assembling the parts.

Embodiment 10: The method according to any of Embodiments 1 through 9, wherein applying heat to the physical instance of the object comprises sintering the physical instance of the object.

Embodiment 11: A method comprising: obtaining a build file comprising instructions for additively manufacturing an object, a dimension of the object exceeding a predetermined size threshold; performing a mechanical analysis of the object; defining, based at least in part on the mechanical analysis, one or more partition lines in the object, the partition lines partitioning the object into parts such that dimensions of each of the parts do not exceed the predetermined size threshold; and generating part build files based on the build file and the one or more partition lines, the part build files comprising instructions for additively manufacturing the parts.

Embodiment 12: The method according to Embodiment 11, wherein defining the one or more partition lines further comprises identifying one or more low-stress locations in a mechanical model of the object and defining the one or more partition lines proximate the one or more low-stress locations.

Embodiment 13: The method according to any of Embodiments 11 and 12, further comprising performing a thermal analysis of the object, wherein defining the one or more partition lines is further based at least in part on the thermal analysis.

Embodiment 14: The method according to any of Embodiments 11 through 13, wherein generating the part build files further comprises adding complementary features along complementary sides of at least one partition line between two parts.

Embodiment 15: The method according to any of Embodiments 11 through 14, further comprising: generating a physical instance of each part of the object according to the part build files; assembling the physical instances of the parts into a physical instance of the object; and applying heat to the physical instance of the object.

Embodiment 16: A method comprising: obtaining a build file comprising instructions for additively manufacturing an object, a dimension of the object exceeding a predetermined size threshold; performing a thermal analysis of the object; defining, based at least in part on the thermal analysis, one or more partition lines in the object, the partition lines partitioning the object into parts such that dimensions of each of the parts do not exceed the predetermined size threshold; and generating part build files based on the build file and the one or more partition lines, the part build files comprising instructions for additively manufacturing the parts.

Embodiment 17: The method according to Embodiment 16, wherein defining the one or more partition lines further comprises identifying one or more low-temperature-gradient locations in a thermal model of the object and defining the one or more partition lines proximate the one or more low-temperature-gradient locations.

Embodiment 18: The method according to any of Embodiments 16 and 17, further comprising performing a mechanical analysis of the object, wherein defining the one or more partition lines is further based at least in part on the mechanical analysis.

Embodiment 19: The method according to any of Embodiments 16 through 18, wherein generating the part build files further comprises adding complementary features along complementary sides of at least one partition line between two parts.

Embodiment 20: The method according to any of Embodiments 16 through 19, further comprising: generating a physical instance of each part of the object according to the part build files; assembling the physical instances of the parts into a physical instance of the object; and applying heat to the physical instance of the object.

While the present disclosure has been described herein with respect to certain illustrated some embodiments, those of ordinary skill in the art will recognize and appreciate that the present invention is not so limited. Rather, many additions, deletions, and modifications to the illustrated and described some embodiments may be made without departing from the scope of the invention as hereinafter claimed along with their legal equivalents. In addition, features from one some embodiment may be combined with features of another some embodiment while still being encompassed within the scope of the invention as contemplated by the inventor.

1. A method comprising:
defining one or more partition lines in an object of a build file, the build file comprising instructions for additively manufacturing a physical implementation of the object of the build file;
generating part build files based on the build file and the one or more partition lines, the part build files comprising instructions for additively manufacturing parts of the object;
generating a physical instance of each part of the object according to the part build files;
assembling the physical instances of the parts into a physical instance of the object; and
applying heat to the physical instance of the object.

2. The method of claim 1, wherein defining the one or more partition lines further comprises defining the one or more partition lines based at least in part on a mechanical model of the object.

3. The method of claim 1, wherein defining the one or more partition lines further comprises identifying one or more low-stress locations in a mechanical model of the object and defining the one or more partition lines proximate the one or more low-stress locations.

4. The method of claim 1, wherein defining the one or more partition lines further comprises defining the one or more partition lines based at least in part on a thermal model of the object.

5. The method of claim 1, wherein defining the one or more partition lines further comprises identifying one or more low-temperature-gradient locations in a thermal model of the object and defining the one or more partition lines proximate the one or more low-temperature-gradient locations.

6. The method of claim 1, wherein defining the one or more partition lines in the object further comprises defining the partition lines such that dimensions of each of the parts do not exceed a predetermined size threshold.

7. The method of claim 1, wherein generating the part build files further comprises adding complementary features along complementary sides of at least one partition line between two parts.

8. The method of claim 1, wherein generating the parts further comprises generating the parts through binder jetting.

9. The method of claim 1, further comprising adding finishing material to edges of the parts corresponding to partition lines before assembling the parts.

10. The method of claim 1, wherein applying heat to the physical instance of the object comprises sintering the physical instance of the object.

11. A method comprising:
obtaining a build file comprising instructions for additively manufacturing an object, a dimension of the object exceeding a predetermined size threshold;
performing a mechanical analysis of the object;
defining, based at least in part on the mechanical analysis, one or more partition lines in the object, the partition lines partitioning the object into parts such that dimensions of each of the parts do not exceed the predetermined size threshold; and
generating part build files based on the build file and the one or more partition lines, the part build files comprising instructions for additively manufacturing the parts.

12. The method of claim 11, wherein defining the one or more partition lines further comprises identifying one or more low-stress locations in a mechanical model of the object and defining the one or more partition lines proximate the one or more low-stress locations.

13. The method of claim 11, further comprising performing a thermal analysis of the object, wherein defining the one or more partition lines is further based at least in part on the thermal analysis.

14. The method of claim 11, wherein generating the part build files further comprises adding complementary features along complementary sides of at least one partition line between two parts.

15. The method of claim 11, further comprising:
generating a physical instance of each part of the object according to the part build files;
assembling the physical instances of the parts into a physical instance of the object; and
applying heat to the physical instance of the object.

16. A method comprising:
obtaining a build file comprising instructions for additively manufacturing an object, a dimension of the object exceeding a predetermined size threshold;
performing a thermal analysis of the object;
defining, based at least in part on the thermal analysis, one or more partition lines in the object, the partition lines partitioning the object into parts such that dimensions of each of the parts do not exceed the predetermined size threshold; and
generating part build files based on the build file and the one or more partition lines, the part build files comprising instructions for additively manufacturing the parts.

17. The method of claim 16, wherein defining the one or more partition lines further comprises identifying one or more low-temperature-gradient locations in a thermal model of the object and defining the one or more partition lines proximate the one or more low-temperature-gradient locations.

18. The method of claim 16, further comprising performing a mechanical analysis of the object, wherein defining the one or more partition lines is further based at least in part on the mechanical analysis.

19. The method of claim 16, wherein generating the part build files further comprises adding complementary features along complementary sides of at least one partition line between two parts.

20. The method of claim 16, further comprising:
generating a physical instance of each part of the object according to the part build files;
assembling the physical instances of the parts into a physical instance of the object; and
applying heat to the physical instance of the object.

21. An additively-manufactured product, wherein the additively-manufactured product is manufactured by a method comprising:
defining one or more partition lines in an object of a build file, the build file comprising instructions for additively manufacturing a physical implementation of the object of the build file;
generating part build files based on the build file and the one or more partition lines, the part build files comprising instructions for additively manufacturing parts of the object;
generating a physical instance of each part of the object according to the part build files;
assembling the physical instances of the parts into a physical instance of the object; and
applying heat to the physical instance of the object.

22. An additively-manufactured product comprising:
an object composed of a number of parts joined together, each of the number of parts comprising one or more complementary edges, the one or more complementary edges defined by partition lines that partition the object into the number of parts, the partition lines having been defined at least partially based on one or both of a mechanical analysis of the object and a thermal analysis of the object, the parts of the object having been assembled, the complementary edges of the assembled parts having been joined together through the application of heat.

23. The additively-manufactured product of claim 22, wherein the complementary edges comprise complementary features to increase a surface area of the complementary edges.

24. The additively-manufactured product of claim 23, wherein the complementary features comprise one or more of: a complementary protrusion and recess, a complementary pin and socket, a complementary split pin and socket, a complementary hollow cylinder and shaft or piston.

25. The additively-manufactured product of claim 22, wherein the partition lines having been defined at least partially based on the object exceeding a predetermined size threshold and wherein the partition lines having been defined such that none of the number of parts exceeds the predetermined size threshold.
